(19) United States
(12) Patent Application Publication
(10) Pub. No.: US 2015/0262603 A1
(43) Pub. Date: Sep. 17, 2015

(54) PERPENDICULAR MAGNETIC RECORDING MEDIUM WITH GRAIN ISOLATION LAYER

(71) Applicant: HGST Netherlands B.V., Amsterdam (NL)

(72) Inventors: Shun Tonooka, Kanagawa (JP); Masayoshi Shimizu, Kanagawa (JP); Ichiro Tamai, Kanagawa (JP); Hiroyuki Nakagawa, Kanagawa (JP)

(73) Assignee: HGST Netherlands B.V., Amsterdam (NL)

(21) Appl. No.: 14/212,449

(22) Filed: Mar. 14, 2014

(51) Int. Cl. G11B 5/667; G11B 5/851; G11B 5/73; G11B 5/738; G11B 5/64; G11B 5/65

(52) U.S. Cl. CPC G11B 5/667; G11B 5/647; G11B 5/653; G11B 5/732; G11B 5/738; G11B 5/851

(57) ABSTRACT

A perpendicular magnetic recording medium with an grain isolation layer is disclosed. In one embodiment, a perpendicular magnetic recording medium comprising a substrate, a soft magnetic under layer formed over the substrate, a seed layer comprising an upper layer and a lower layer formed over the soft magnetic underlayer, an intermediate layer formed of Ru or an Ru alloy formed over the seed layer and a recording layer formed over the intermediate layer, forming a grain isolation layer on the upper layer of the seed layer is provided.

### TECHNICAL FIELD

Embodiments of the present technology relate to perpendicular magnetic recording medium capable of recording a large volume of information, and a magnetic recording medium using the same.

### BACKGROUND

Many perpendicular magnetic recording media supplied to the market today have a configuration in which a soft magnetic under-layer (SUL), a seed layer formed of a Ni alloy, an intermediate layer formed of Ru (Ruthenium) or an Ru alloy, a recording layer, a carbon overcoat, and a lubricant layer are laminated in this order on a nonmagnetic substrate. In some prior art examples, the recording layer has a granular layer containing an oxide and having a granular structure, and a ferromagnetic metal cap layer not containing an oxide and not having a clear granular structure.

Refining the grain size is an effective means of improving the SNR (signal to noise ratio) of this perpendicular magnetic recording medium. One method of refining the grain size is to thin the seed layer. Thinning the seed layer has another advantage. This reduces the surface roughness of the medium. Reducing the surface roughness of the medium improves medium clearance, which may result in further improvement of the SNR. Thinning the seed layer by conventional methods, however, has disadvantage.

For example, such thinning increases lateral exchange coupling within the recording layer. Increasing lateral exchange coupling increases noise, which does not improve the SNR. To address this, some prior art examples have provided a seed layer containing an oxide. Containing an oxide in the seed layer promotes grain separation of the Ru intermediate layer and the recording layer formed in the upper layers, which reduces lateral exchange of the recording layer. As a result, the recording layer can apparently achieve little lateral exchange even in the case that the seed layer has been thinned.

### BRIEF DESCRIPTION OF THE DRAWINGS

The accompanying drawings, which are incorporated in and form a part of this specification, illustrate embodiments of the present technology and, together with the description, serve to explain the embodiments of the present technology:

FIG. 1 shows a diagram representing the layer configuration in accordance with embodiments of the present invention.

FIG. 2 shows a change in grain size when the film thickness of the seed layer was varied in accordance with embodiments of the present invention.

FIG. 3 shows a change in surface roughness when the film thickness of the seed layer was varied in accordance with embodiments of the present invention.

FIG. 4 shows a change in touch down power (TDP) when the film thickness of the seed layer was varied in accordance with embodiments of the present invention.

FIG. 5 shows a change in magnetic cluster size when the film thickness of the seed layer was varied in accordance with embodiments of the present invention.

FIG. 6 shows a change in switching field distribution (SFD) when the film thickness of the seed layer was varied in accordance with embodiments of the present invention.

FIG. 7 shows a change in SNR when the film thickness of the seed layer was varied in accordance with embodiments of the present invention.

FIG. 8 shows a change in grain size when the film thickness of the grain isolation layer was varied in accordance with embodiments of the present invention.

FIG. 9 shows a change in surface roughness when the film thickness of the grain isolation layer was varied in accordance with embodiments of the present invention.

FIG. 10 shows a change in touch down power when the film thickness of the grain isolation layer was varied in accordance with embodiments of the present invention.

FIG. 11 shows a change in magnetic cluster size when the film thickness of the grain isolation layer was varied in accordance with embodiments of the present invention.

FIG. 12 shows a change in SFD when the film thickness of the grain isolation layer was varied in accordance with embodiments of the present invention.

FIG. 13 shows a change in Δθ50 when the film thickness of the grain isolation layer was varied in accordance with embodiments of the present invention.

FIG. 14 shows a change in SNR when the film thickness of the grain isolation layer was varied in accordance with embodiments of the present invention.

FIG. 15 shows a change in grain size when the film thickness of the seed layer was varied in accordance with embodiments of the present invention.

FIG. 16 shows a change in Δθ50 when the film thickness of the seed layer was varied in accordance with embodiments of the present invention.

FIG. 17 shows a change in surface roughness when the film thickness of the seed layer was varied in accordance with embodiments of the present invention.

FIG. 18 shows a change in SNR when the film thickness of the seed layer was varied in accordance with embodiments of the present invention.

FIG. 19A shows a schematic sectional view of a magnetic recording medium in accordance with embodiments of the present invention.

FIG. 19B shows a side view of a magnetic recording medium in accordance with embodiments of the present invention.

FIG. 20 shows the relationship between the magnetic head and the magnetic recording medium in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present technology. While the technology will be described in conjunction with the alternative embodiments, it will be understood that they are not intended to limit the technology to these embodiments. On the contrary, the technology is intended to cover alternatives, modifications and equivalents, which may be included within the spirit and scope of the technology as defined by the appended claims.

Furthermore, in the following description of embodiments of the present technology, numerous specific details are set forth in order to provide a thorough understanding of the present technology. However, it should be noted that embodiments of the present technology may be practiced without these specific details. In other instances, well known methods, procedures, and components have not been described in detail as not to unnecessarily obscure embodiments of the present technology. Throughout the drawings, like components are denoted by like reference numerals, and repetitive descriptions are omitted for clarity of explanation if not necessary.

### Overview

Refining the grain size and reducing lateral exchange are important problems for improving the SNR during development of a medium. Refining the grain size and decreasing lateral exchange of the recording layer, however, are usually difficult to achieve simultaneously. That is, the two are in a trade-off relationship. One of the problems addressed by the present invention is to correct this trade-off relationship. Another problem addressed by the present invention is to reduce lateral exchange while maintaining the SFD and the surface roughness of the medium. Solving these two problems can be expected to greatly improve the SNR.

Results of study by the present inventors, however, revealed that the surface roughness of the medium is increased with such a seed layer. Increasing the surface roughness of the medium worsens medium clearance, which does not improve the SNR. Results of further study by the present inventors revealed that simply containing an oxide in the seed layer greatly disturbs the crystal orientation of the Ru formed as an upper layer of the seed layer. As a result, the SFD (switching field distribution) of the recording layer greatly worsens, which increases noise.

Study of the present invention revealed that forming a grain isolation layer containing an oxide in an upper layer of a seed layer not containing an oxide solves all of these problems. Specifically, the present invention can achieve sufficiently little lateral exchange even in the case that thinning the seed layer has achieved a fine grain size. At the same time, the present invention can maintain good surface roughness and good crystal orientation, which can improve the SNR.

### Overview Description of Embodiments of the Present Technology Perpendicular Recording Medium with Grain Isolation Layer

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview of Structure

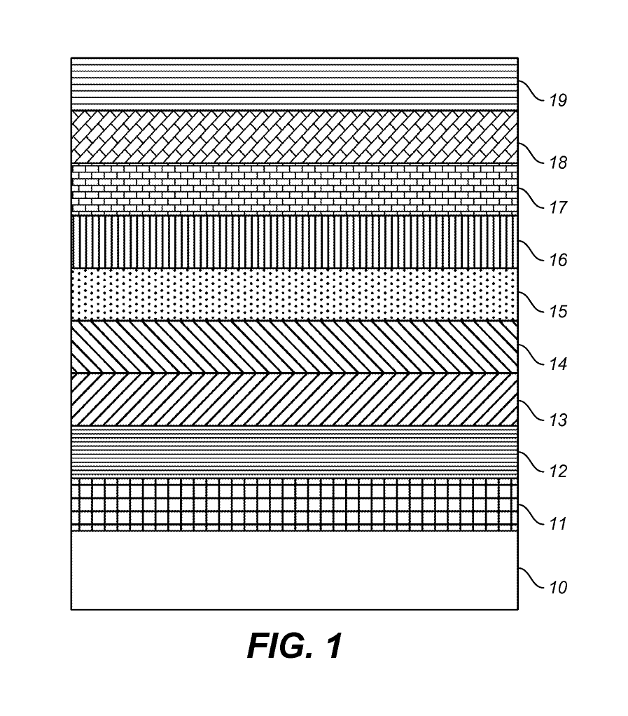

FIG. 1 shows the layer structure of a typical perpendicular magnetic recording medium of the present invention. In this perpendicular magnetic recording medium, an adhesion layer 11, a soft magnetic under layer 12, a seed layer 13, a grain isolation layer 14, and an intermediate layer 15 are formed in this order on a substrate 10. The intermediate layer is formed of Ru or an Ru alloy.

A granular recording layer 16 and a ferromagnetic metal cap layer 17 are formed in this order as a recording layer on top of this layer, and a carbon overcoat 18 and a lubricant layer 19 are formed in this order on top of these layers. Of these layers, the method of configuring the seed layer 13 and the grain isolation layer 14 is the feature of this perpendicular magnetic recording medium. The other layers are not specifically limited as to materials or configuration method provided that they are formed with the same object.

The seed layer 13 has the role of controlling the crystal orientation and the grain size. Specifically, the seed layer 13 is formed of an NiW (nickel-tungsten) alloy not containing an oxide, and has, in one embodiment, an orientation of an fcc (111) surface. The NiW alloy may also contain a small amount of an element such Al, Zr, or Nb. Not having a seed layer 13 greatly worsens the crystal orientation and cannot achieve a good SNR. Too thick a seed layer 13, however, makes the grain size too large, and cannot achieve a good SNR. Too thick a seed layer 13 also increases the surface roughness of the medium, and cannot achieve good medium clearance. The seed layer 13 is in one embodiment in the range of 2 nm to 5 nm thick.

The grain isolation layer 14 is formed of an NiW alloy. The grain isolation layer 14 also contains at least one oxide selected from among oxide of Si, Ti, W, Nb, B, and Cr. It is important that the grain isolation layer 14 be formed just above the seed layer 13. During this formation, the grain isolation layer 14 is grown by epitaxial growth on top of the seed layer 13 having an orientation, in one embodiment, in the (111) direction, and achieves a good crystal orientation. It is also important that the grain isolation layer 14 be formed just below the Ru intermediate layer 15. The grain isolation layer 14 has a configuration in which an oxide is segregated around a grain core formed of an NiW alloy. Because it is difficult to form Ru having high surface energy on top of an oxide having low surface energy, the Ru intermediate layer 15 formed in an upper layer is selectively formed on a grain core formed of an NiW alloy.

Therefore, the grain isolation layer 14 has the role of promoting grain separation of the Ru intermediate layer 15. Promoting grain separation of the Ru intermediate layer 15 reduces the lateral exchange of the recording layer and improves the SNR. Too thin a grain isolation layer 14, however, does not promote sufficient grain separation of the Ru intermediate layer 15 and does not improve the SNR. Too thick a grain isolation layer 14 increases the roughness of the upper layer portion of the grain isolation layer 14 too much, which increases the surface roughness of the medium. As a result, medium clearance is poor. The grain isolation layer 14 is preferably 0.5 nm to 3 nm thick.

Additional modes of the layers other than the seed layer 13 and the grain isolation layer 14 in this perpendicular magnetic recording medium will be described hereinafter.

A variety of substrates may be used for the substrate 10, such as a glass substrate, an aluminum alloy substrate, a plastic substrate, or a silicon substrate.

Although not specifically limited provided that it has good adhesion to the substrate 10 and excellent flatness, the adhesive layer 11 preferably contains at least two elements selected from among Ni, Co, Al, Ti, Cr, Zr, Ta, and Nb. Specifically, an alloy such as TiAl, NiTa, TiCr, AlCr, NiTaZr, CoNbZr, TiAlCr, NiAlTi, or CoAlTi may be used. The film thickness is in one embodiment in a range of 2 nm to 40 nm. Thinner than 2 nm gives poor effect as an adhesive layer, and thicker than 40 nm does not improve performance as an adhesive layer and is undesirable due to lowering productivity.

The soft magnetic underlayer 12 has the role of minimizing the extent of the magnetic field generated by a magnetic head and effectively magnetizing the recording layer 16. The soft magnetic underlayer is not specifically limited provided that it imparts uniaxial anisotropy radially to the disk substrate, has coercivity of 2.4 kG/m or less measured in the head moving direction, and has excellent flatness. Specifically, making the soft magnetic underlayer an amorphous alloy comprising primarily Co or Fe and doped with Ta, Nb, Zr, B, Cr, or the like facilitates obtaining these characteristics. Although the film thickness differs depending on the distance from the soft magnetic underlayer 12 to the recording layer 16, the material, and the magnetic head with which the medium is assembled, in one embodiment, the film thickness is preferably in a range of 10 nm to 50 nm.

The intermediate layer 15 enhances the crystal orientation of the recording layer 16. Specifically, Ru or an Ru alloy having an hcp structure of Ru doped with an element selected from among Cr, Ta, W, Mo, Nb, Co, or the like may be used. Good crystal orientation and grain isolation can be achieved simultaneously by varying formation conditions and materials in stages. Specifically, a layer may be formed by a method of forming a layer under a low gas pressure at the start of film formation with the object of enhancing crystal orientation, and increasing the gas pressure just before film formation ends with the object of promoting more grain isolation; or in two or three stages under different gas pressure or material conditions. The “low gas pressure” is specifically 1 Pa or less.

The “high gas pressure” is in a range of 2 Pa to 6 Pa, a range which increases the surface roughness of Ru and forms spaces in the grain boundary areas. The film thickness is preferably in a range of 8 nm to 20 nm. Thinner than 8 nm worsens crystal orientation, and thicker than 20 nm widens the gap between the magnetic head and the soft magnetic layer, which undesirably makes writeability poor and makes high density recording difficult.

An Ru alloy containing an oxide may be used in an upper layer portion of the intermediate layer 15 with the object of promoting grain separation of the granular recording layer 16 even more. Specifically, a material may be formed which contains an oxide of at least one element selected from among Si, Ti, W, and Nb in Ru or an Ru alloy.

The granular recording layer 16 is formed of a magnetic alloy comprising primarily Co, Cr, and Pt. The granular recording layer 16 may also contain Ru, B, or Ta. The granular recording layer 16 may further contain at least one oxide selected from among oxides of Si, Ti, Ta, W, B, Cr, and Nb.

The ferromagnetic metal cap layer 17 is formed of a magnetic alloy comprising primarily Co, Cr, Pt, and B. The ferromagnetic metal cap layer 17 may also be doped with an element selected from among Ta, Ru, Ti, and W.

The optimum mode for taking advantage of the effects of the present invention has been described above. The adhesion layer 11, the Ru intermediate layer 15, the granular recording layer 16, and the ferromagnetic metal cap layer 17, however, may be adjusted in conformity with the saturation magnetic flux density (Bs) and film thickness of the soft magnetic underlayer 12 and the properties of the magnetic head, and are not specifically limited as to materials or film thickness.

The overcoat layer 18 preferably forms a film of 1 nm to 5 nm thickness comprising primarily carbon. The liquid lubricant layer 19 is preferably a lubricant layer such as perfluoroalkyl polyether. As a result, a highly reliable magnetic recording medium is obtained.

The present invention reduces lateral exchange of the recording layer without enlarging the grain size. The present invention can also reduce lateral exchange of the recording layer while maintaining good switching field distribution and surface roughness of the medium. As a result, the present invention can reduce noise and improve the SNR. An improved SNR is essential for increasing areal density, and using such as perpendicular magnetic recording medium can provide a compact and high-capacity magnetic recording device.

The technology of the present invention can be applied to media for PMR (perpendicular magnetic recording) or SMR (single-write magnetic recording). The technology can also be applied in principle to media for MAMR (microwave-assisted magnetic recording) or HAMAR (heat-assisted magnetic recording) in media configurations having an NiW alloy seed layer and a Ru intermediate layer.

### Description of Examples of the Present Technology Perpendicular Recording Medium with Grain Isolation Layer

FIG. 1 is a schematic diagram representing a cross-section of a perpendicular magnetic recording medium comprising an example of the present invention. The perpendicular magnetic recording medium of the present example was fabricated using a sputtering system Lean 200. After all chambers had been evacuated to a degree of vacuum of 2×10-5 Pa or less, a carrier on which a substrate had been set was moved through each process chamber and subjected to successive processes. The adhesion layer 11, the soft magnetic underlayer 12, the seed layer 13, the grain isolation layer 14, the intermediate layer 15, the granular recording layer 16, and the ferromagnetic metal cap layer 17 were formed in this order on the substrate 10 by DC magnetron sputtering, and DLC (diamond-like carbon) was formed as the overcoat layer 18. Finally, a lubricant comprising a perfluoroalkyl polyether material diluted with a fluorocarbon material was coated as the lubricant layer 19.

A glass substrate of 0.8 mm thickness and 65 mm diameter was used for the substrate 10. Without heating the substrate, Ni-37.5Ta was formed as the adhesion layer 11 to a thickness of 15 nm under a condition of 0.5 Pa Ar gas pressure, and the soft magnetic underlayer 12 was formed in two layers of an Ru film having a thickness of 0.4 nm followed by a Co-28Fe-3Ta-5Zr alloy film having a thickness of 30 nm under a condition of 0.4 Pa Ar gas pressure. The seed layer 13 and the grain isolation layer 14 were formed over this in this order under a condition of 0.5 Pa Ar gas pressure.

The intermediate layer 14, in which the film thickness of the seed layer and the film thickness of the grain isolation layer were varied as shown in Table 1, was formed as follows. After Ru having a thickness of 4 nm had been formed under a condition of 0.5 Pa Ar gas pressure, Ru having a thickness of 5 nm was formed under a condition of 3.3 Pa Ar gas pressure, and Ru having a thickness of 5 nm was formed over this under a condition of 6.0 Pa Ar gas pressure. Next, a layer was formed over this to a thickness of 0.5 nm under a condition of 4 Pa Ar gas pressure using a Ru-10TiO2 target.

A granular recording layer comprised three layers. In order from closest to the substrate, a layer was formed to a thickness of 4 nm using a [Co-10Cr-22Pt]-4SiO2-4TiO2-1.5Co3O4 target under conditions of 4 Pa Ar gas pressure and −150 V substrate bias, a layer was formed over this to a thickness of 3 nm using a [Co-18Cr-22.5Pt]-4SiO2-2.5Co3O4 target under a condition of 2 Pa Ar gas pressure, and a layer was formed over this to a thickness of 4.5 nm using a [Co-26Cr-10.5Pt]-4SiO2-1Co3O4 target under a condition of 1 Pa Ar gas pressure. The ferromagnetic metal cap layer 17 was formed to a film thickness of 3.5 nm using a Co-15Cr-14Pt-8B target under a condition of 0.5 Pa gas pressure. A DLC film was formed as the overcoat layer 18 to a thickness of 2.5 nm. Finally, a lubricant comprising a perfluoroalkyl polyether material diluted with a fluorocarbon material was coated as the lubricant layer 19.

TABLE 1

| | | | | grain |
|---|---|---|---|---|
| | | seed | grain | isolation |
| | seed | thick- | isolation | layer |
| | layer | ness | layer | thickness |
| | alloy | (nm) | alloy | (nm) |
| Comp. 1-1 | Ni—6W | 0.0 | (Ni—6W)—3WO3 | 0.0 |
| Comp. 1-2 | ↑ | 1.0 | ↑ | 0.0 |
| Comp. 1-3 | ↑ | 2.0 | ↑ | 0.0 |
| Comp. 1-4 | ↑ | 3.0 | ↑ | 0.0 |
| Comp. 1-5 | ↑ | 4.0 | ↑ | 0.0 |
| Comp. 1-6 | ↑ | 5.0 | ↑ | 0.0 |
| Comp. 1-7 | ↑ | 6.0 | ↑ | 0.0 |
| Comp. 1-8 | ↑ | 7.0 | ↑ | 0.0 |
| Comp. 1-9 | ↑ | 0.0 | ↑ | 6.0 |
| Comp. | ↑ | 3.0 | ↑ | 0.0 |
| 1-10 | | | | |
| EX. 1-1 | ↑ | 3.0 | ↑ | 0.5 |
| Ex. 1-2 | ↑ | 3.0 | ↑ | 1.0 |
| Ex. 1-3 | ↑ | 3.0 | ↑ | 1.5 |
| Ex. 1-4 | ↑ | 3.0 | ↑ | 2.0 |
| Ex. 1-5 | ↑ | 3.0 | ↑ | 3.0 |
| Comp. | ↑ | 3.0 | ↑ | 4.0 |
| 1-11 | | | | |
| Comp. | ↑ | 3.0 | ↑ | 5.0 |
| 1-12 | | | | |
| Comp. | (Ni—6W)—3WO3 | 2.0 | Ni—6W | 3.0 |
| 1-13 | | | | |

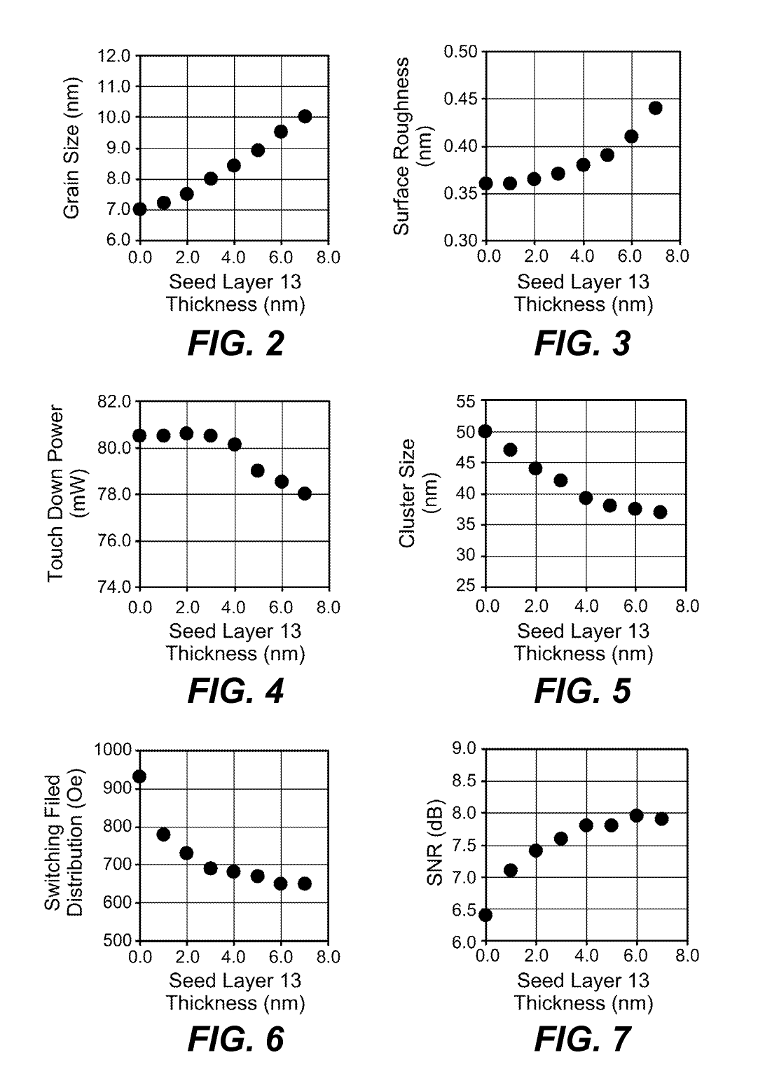

Table 1 shows the materials and film thicknesses of the seed layer 13 and the grain isolation layer 14 used in the present example. To investigate the micro structure of the recording layer of the fabricated samples, a high-resolution transmission electron microscope (TEM) was used to observe the planar structure of each sample. The grain size was measured as follows. The grain size was found as the average grain pitch using the planar structure of a 160 nm×90 nm area observed using a TEM. FIG. 2 shows the grain size when the grain isolation layer 14 was omitted and Ni-6W was used as a seed layer not containing an oxide in the seed layer 13.

The vertical axis shows the grain size found by the method just described. In FIG. 2, increasing the film thickness of Ni-6W from 0 nm to 7 nm steadily increased the grain size. Therefore, it is clear that a thin film thickness of Ni-6W must be designed to realize a small grain size. FIG. 3 shows change in the surface roughness of the medium plotted when the film thickness of Ni-6W was varied. The surface roughness of the medium was estimated as the average roughness (Ra) using atomic force microscopy (AFM). The diagram reveals that the thinner the film thickness of Ni-6W, the lower the surface roughness of the medium. That is, touch down power (TDP) during a read/write test is improved as a result as shown in FIG. 4. Touch down power is the electric power charged by a thermal fly-height control (TFC) element attached to a slider of the head until the surface of the medium is contacted. The greater the TDP, the closer the head can be lowered to the surface of the medium. These results reveal that a small-grain medium can reduce the surface roughness of the medium and achieve a good TDP. Simply thinning the seed layer 13, that is, thinning the film thickness of Ni-6W, however, has the following disadvantages.

FIGS. 5 and 6 show change in magnetic cluster size and switching field distribution (SFD) when the film thickness of Ni-6W was varied. The magnetic cluster size and SFD were found by a method of analyzing a minor loop measured using a Kerr magnetometer. The level of saturation magnetization (Ms) measured using a vibrating sample magnetometer (VSM) was used to correct the absolute value of magnetization. The details of the method to analyze the cluster size and SFD are described in the following paper. H. Nemoto, et al., “Designing magnetic of capped perpendicular media with minor-loop analysis”, J. M M M, 320 (2008) 3144-3150. FIGS. 5 and 6 reveal that the cluster size increases and the SFD widens as the film thickness of Ni-6W becomes thinner. Usually, a good read/write (R/W) performance may be obtained by a small cluster size and a narrow SFD. Therefore, the disadvantages of a small-grain medium achieved by simply thinning the seed layer 13 are said to be a large cluster size and a wide SFD.

FIG. 7 shows change in the signal-to-noise ratio (SNR) when the film thickness of Ni-6W was varied. The SNR was assessed using a spinstand. The assessment was carried out using a single magnetic-pole recording element with a track width of 70 nm and a magnetic head having a reading element with a track width of 60 nm and using a tunneling magnetoresistance effect, under conditions of 10 m/sec peripheral speed, 0° skew angle, and about 8 nm magnetic spacing. The SNR was found when recording a 1184 kfci recording pattern. According to FIG. 7, reducing the film thickness of Ni-6W from 7 nm reduced the SNR. Specifically, FIG. 7 reveals that simply reducing the film thickness of the seed layer 13 to reduce the grain size improves the TDP, but increases the cluster size and the SFD, and worsens R/W performance.

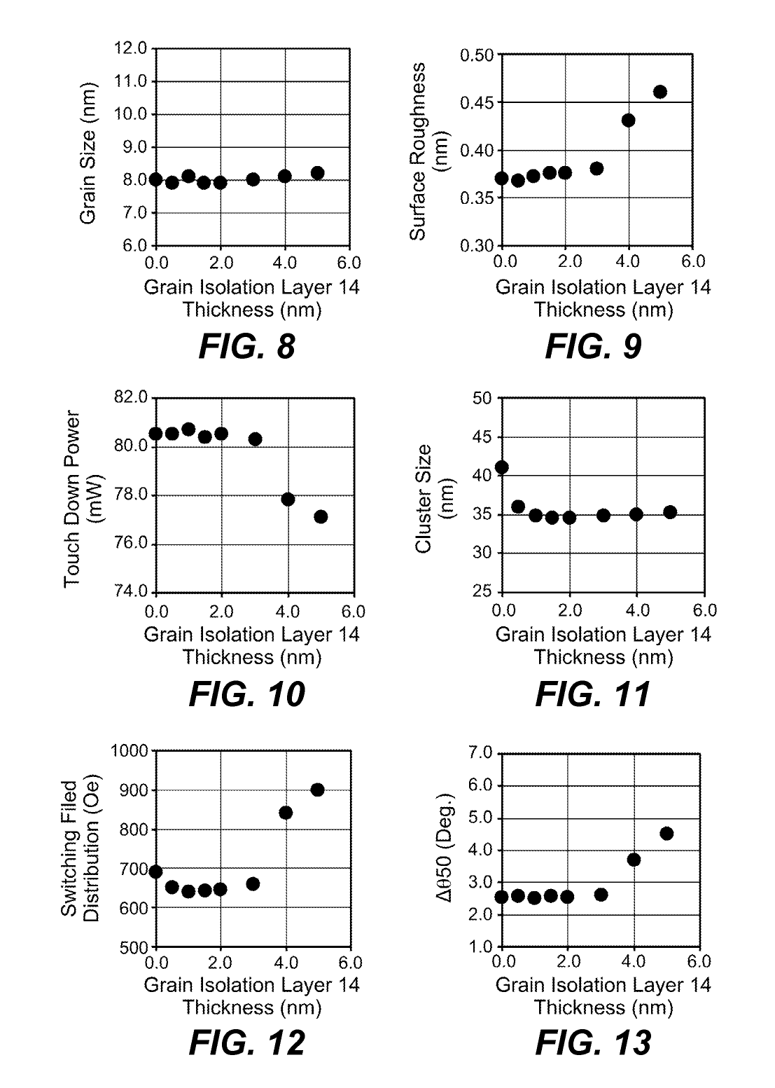

Next, samples were prepared using Ni-6W for the seed layer 13, fixing the film thickness of this layer at 3 nm, and varying the film thickness of the grain isolation layer 14 from 0 nm to 5 nm. Ni-6W-3WO3 was used for the grain isolation layer 14. FIG. 8 shows change in grain size when the film thickness of the grain isolation layer 14 was varied. Grain size did not change even when the film thickness of the grain isolation layer 14 was varied. FIG. 9 shows change in surface roughness when the grain isolation layer 14 was varied. Surface roughness did not vary when the grain isolation layer 14 was 3 nm or less, but surface roughness varied when the layer was greater than 3 nm. FIG. 10 shows change in touch down power when the grain isolation layer 14 was varied. Like the change in surface roughness, touch down power did not change when the grain isolation layer 14 was 3 nm or less, but touch down power varied when the layer was greater than 3 nm. Therefore, the grain isolation layer 14 must be 3 nm or less. FIG. 11 shows change in magnetic cluster size when the film thickness of the grain isolation layer 14 was varied. FIG. 11 reveals that forming the grain isolation layer 14 decreases magnetic cluster size.

This suggests that the grain isolation layer 14 promoted grain separation of the Ru intermediate layer, which reduced lateral exchange coupling of the granular recording layer. As shown in FIG. 12, the SFD does not vary greatly with variation in the film thickness of the grain isolation layer 14 when the grain isolation layer 14 is 3 nm of less. FIG. 13 shows change in crystal orientation (Δθ50) when the film thickness of the grain isolation layer 14 was varied. Δθ50 was assessed using a thin-film x-ray diffractometer. Cu-Ká radiation was used, the tube voltage was set to 45 kV, and the tube current was set to 200 mA. Δθ50 was assessed by finding 2θ from the (0004) diffraction peak of a recording layer measured using a θ-2θ scan method to measure the rocking curve. A higher level of Δθ50 means a greater c-axial dispersion of the recording layer and poor crystal orientation.

According to FIG. 13, the crystal orientation does not change in a range of film thickness in which the grain isolation layer 14 is 3 nm or less, but varies when the film thickness is 3 nm or greater. This suggests that the grain isolation layer 14 undergoes epitaxial growth on the seed layer 13 and can achieve good crystal orientation in a range of film thickness in which the grain isolation layer 14 is thin, but the crystal orientation becomes disturbed due to containing an oxide when the film thickness of the grain isolation layer 14 is too thick. Summarizing these results, when the grain isolation layer 14 is in a range of film thickness from 0.5 nm to 3 nm, magnetic cluster size can be reduced while maintaining good SFD, crystal orientation, surface roughness, and touch down power.

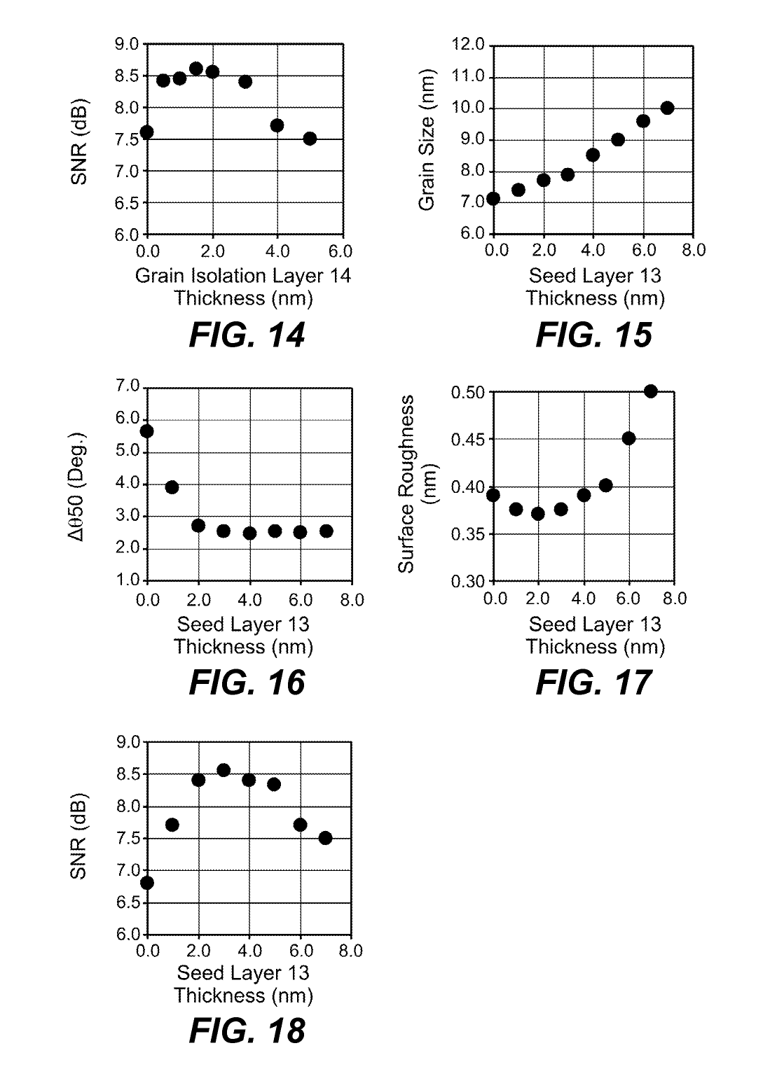

FIG. 14 shows change in the SNR when the film thickness of the grain isolation layer 14 was varied. Forming the grain isolation layer 14 greatly improves the SNR, and can achieve a good SNR in a range of 0.5 nm to 3 nm. The level of SNR is better than the highest level of SNR in FIG. 7. That is, the SNR is better than in a conventional medium of large grain size in which the grain isolation layer 14 was omitted and the seed layer 13 was formed to a thickness of 7 nm. Therefore, using the grain isolation layer 14 can improve the SNR by achieving sufficiently little lateral exchange even in the case that the grain size has been refined.

Next, a sample was prepared by forming Ni-6W-3WO3 to a thickness of 3 nm as the seed layer 13, and forming Ni-6W to a thickness of 2 nm as the grain isolation layer 14. The layers other than the seed layer 13 and the grain isolation 14 were formed under the same conditions as earlier. The Δθ50 of this sample had a poor crystal orientation of 3.7 (deg), and great surface roughness of 0.48 nm. As a result, the SNR was a low 7.4 dB, and R/W performance was poor. These results reveal that the seed layer 13 is preferably an NiW alloy not containing an oxide, and the grain isolation layer 14 is preferably an NiW alloy containing an oxide.

### Example 2

The perpendicular magnetic recording medium of the present example was fabricated using the same sputtering process as in Example 1 except for the seed layer 13 and the grain isolation layer 14. The seed layer 13 was formed of Ni-6W, and the grain isolation layer 14 was formed of Ni-6W-3WO3. The film thickness of the grain isolation layer 14 was fixed at 2 nm, and the film thickness of the seed layer 13 was varied from 0 nm to 7 nm. The method of assessing the properties of the medium was the same as in Example 1. FIG. 15 shows change in grain size when the film thickness of the seed layer 13 was varied, and reveals that grain size was enlarged when the film thickness of the seed layer 13 was thicker.

Therefore, the film thickness of the seed layer 13 must be thin to achieve a small grain size. FIG. 16 shows change in crystal orientation (Δθ50) when the film thickness of the seed layer 13 was varied. Δθ50 is poor when the film thickness of the seed layer 13 is 0 nm. That is, crystal orientation greatly worsens in the case that the seed layer 13 is not formed. Not forming the seed layer 13 means that the grain isolation layer 14 is grown directly on top of the soft magnetic underlayer 12. Doing so worsens the crystal orientation of the grain isolation layer 14 in the fcc (111) direction.

As a result, the crystal orientation of the recording layer is disturbed. Even in the case that the seed layer 13 is formed, crystal orientation is poor when the film thickness is 2 nm or less. This suggests that the crystal orientation of the seed layer 13 in the fcc (111) direction is insufficient due to too thin a film thickness in the case that the seed layer 13 is thinner than 2 nm. Therefore, to achieve good crystal orientation in the (111) direction of the grain isolation layer 14 containing an oxide, the seed layer 13 containing no oxide must be formed just below the grain isolation layer 14 to a thickness of 2 nm or greater.

FIG. 17 shows change in surface roughness when the film thickness of the seed layer 13 was varied. Although good surface roughness can be maintained when the seed layer 13 is 5 nm or less, surface roughness greatly worsens when the thickness is greater than 5 nm. Therefore, the seed layer 13 must be 5 nm or less.

FIG. 18 shows change in the SNR when the film thickness of the seed layer 13 was varied. A good SNR is found when the seed layer 13 is 2 nm to 5 nm. When the seed layer 13 is thinner than 2 nm, crystal orientation is insufficient, and when the layer is thicker than 5 nm, surface roughness is increased, which worsens the TDP. The seed layer 13 must be 2 nm to 5 nm.

### Example 3

The perpendicular magnetic recording medium of the present example was fabricated using the same sputtering process as in Example 1 except for the seed layer 13, the grain isolation layer 14, and the Ru intermediate layer. The seed layer 13 was formed to a film thickness of 3 nm using Ni-6W. The grain isolation layer 14 was formed to a film thickness of 2 nm using Ni-6W-3WO3. The intermediate layer 14 was formed as follows. After an Ru alloy having a thickness of 4 nm had been formed under a condition of 0.5 Pa Ar gas pressure, Ru having a thickness of 5 nm was formed under a condition of 3.3 Pa Ar gas pressure, and Ru have a thickness of 5 nm was formed over this under a condition of 6.0 Pa Ar gas pressure.

TABLE 2

| | Intermediate layer | grain size | | | | Surface roughness | |
|---|---|---|---|---|---|---|---|
| | alloy | (nm) | Dn (nm) | SFD (Oe) | Δθ50 (deg) | (nm) | SNR (dB) |
| Ex. 3-1 | Ru | 7.9 | 34.6 | 645 | 2.52 | 0.38 | 8.6 |
| Ex. 3-2 | Ru—20Ta | 7.8 | 34.5 | 650 | 2.53 | 0.37 | 8.5 |
| Ex. 3-3 | Ru—20Cr | 7.8 | 34.8 | 640 | 2.48 | 0.38 | 8.6 |
| Ex. 3-4 | Ru—3SiO2 | 7.7 | 34.3 | 660 | 2.52 | 0.39 | 8.4 |

Table 2 shows results for grain size, cluster size, SFD, Δθ50, surface roughness, and SNR when a doping material of an Ru alloy formed under a condition of 0.5 Pa Ar gas pressure was varied. The table reveals that good characteristics were obtained even when Ru was doped with a material such as Cr, Ta, or SiO2.

### Example 4

The perpendicular magnetic recording medium of the present example was fabricated using the same sputtering process as in Example 1 except for the seed layer 13 and the grain isolation layer 14. The seed layer 13 was formed to a film thickness of 3 nm using Ni-6W or Ni-6W-14Fe.

TABLE 3

| | | | | Cluster | | | | |
|---|---|---|---|---|---|---|---|---|
| | | grain isolation layer | grain size | size | | | Surface roughness | |
| | seed alloy | alloy | (nm) | (nm) | SFD (Oe) | Δθ50 (deg) | (nm) | SNR (dB) |
| Ex. 4-1 | Ni—6W | (Ni—6W)—3WO3 | 7.9 | 34.6 | 645 | 2.52 | 0.38 | 8.6 |
| Ex. 4-2 | Ni—6W | (Ni—6W)—5WO3 | 7.8 | 34.4 | 650 | 2.55 | 0.39 | 8.6 |
| Ex. 4-3 | Ni—6W | (Ni—6W)—7WO3 | 7.8 | 34.3 | 652 | 2.56 | 0.39 | 8.5 |
| Ex. 4-4 | Ni—6W | (Ni—10W)—3WO3 | 8.0 | 34.7 | 643 | 2.52 | 0.38 | 8.6 |
| Ex. 4-5 | Ni—6W | (Ni—6W)—3SiO2 | 7.8 | 35.0 | 642 | 2.53 | 0.37 | 8.3 |
| Ex. 4-6 | Ni—6W | (Ni—6W)—3TiO2 | 7.9 | 34.9 | 642 | 2.48 | 0.38 | 8.3 |
| Ex. 4-7 | Ni—6W | (Ni—6W)—3Nb2O5 | 8.0 | 34.8 | 644 | 2.54 | 0.37 | 8.4 |
| Ex. 4-8 | Ni—6W | (Ni—6W)—3B2O3 | 7.8 | 34.6 | 650 | 2.53 | 0.37 | 8.5 |
| Ex. 4-9 | Ni—6W | (Ni—6W)—3Cr2O3 | 7.9 | 34.7 | 650 | 2.50 | 0.38 | 8.5 |
| Ex. 4-10 | Ni—6W | (Ni—6W—1Al)—3WO3 | 7.8 | 34.5 | 655 | 2.45 | 0.37 | 8.6 |
| Ex. 4-11 | Ni—6W | (Ni—6W—10Cr)—3WO3 | 7.9 | 34.6 | 653 | 2.50 | 0.38 | 8.5 |
| Ex. 4-12 | Ni—6W | (Ni—6W—14Fe)—3WO3 | 7.8 | 35.2 | 650 | 2.51 | 0.37 | 8.3 |
| Ex. 4-13 | Ni—6W—14Fe | (Ni—6W—14Fe)—3WO3 | 7.8 | 35.0 | 647 | 2.49 | 0.38 | 8.7 |

Table 3 shows results for grain size, cluster size, SFD, Δθ50, surface roughness, and SNR when the material of the grain isolation layer 14 was varied. The results in Table 3 reveal that good characteristics were obtained even when the percentage of an oxide added to the grain isolation layer 14 was increased to 7 at %. The table also reveals that good characteristics were obtained in the case that the material of the NiW alloy or the type of oxide added was varied. The table further reveals that good characteristics were obtained when a magnetic material (NiFeW) was used for the seed layer 13 with the object of reducing head under spacing and improving writeability.

### Example 5

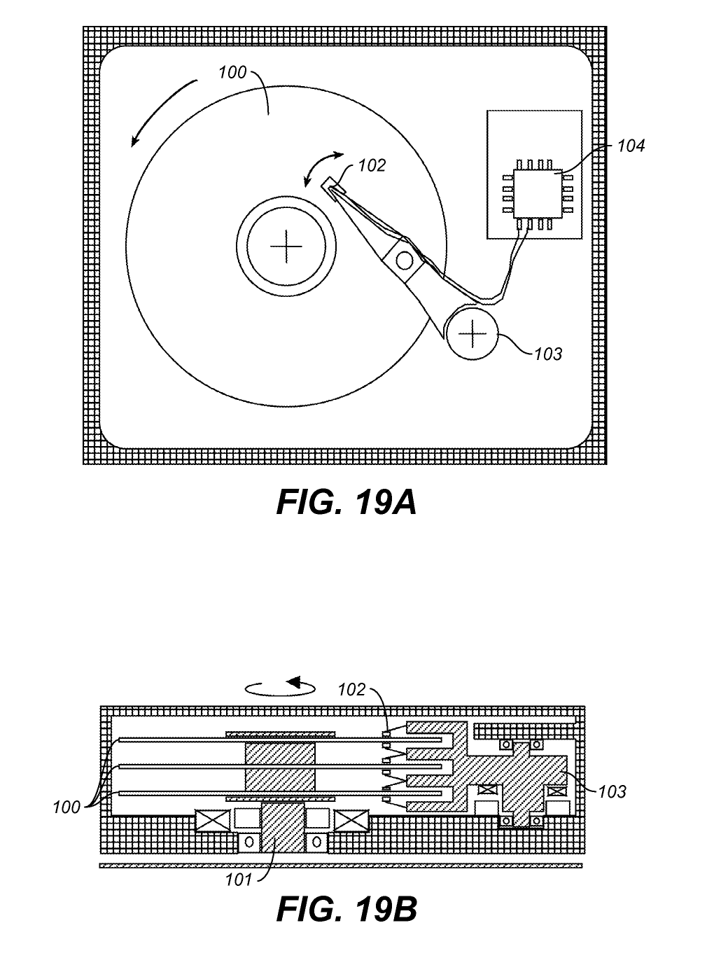

FIGS. 19A and 19B show a schematic sectional view and a side view of a magnetic recording medium of the present invention. A magnetic recording medium 100 comprises the medium of the example described earlier, and comprises a drive unit 101 for driving this magnetic recording medium, a magnetic head 102 comprising a recording element and a reading element, means 103 for moving the magnetic head relative to the magnetic recording medium, and means 104 for inputting and outputting signals to the magnetic head.

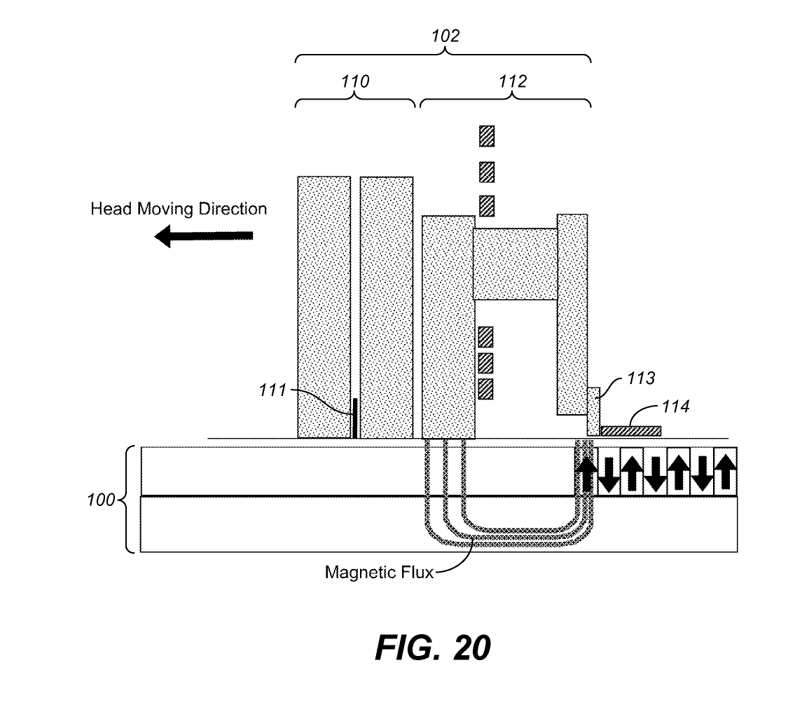

FIG. 20 shows the relationship between the magnetic head 102 and the magnetic recording medium 100. The fly height of the magnetic head was set at 7 nm, a tunneling magnetoresistance effect element (TMR) was used for the reproduction element 111 of the reproducing portion 110, and the head had a wraparound shield 114 formed around the main pole 113 of the recording portion 112. Using a magnetic head having a shield formed around the main pole of the recording element in this way can improve writeability while maintaining a high medium SNR, and operation at 916 gigabytes per square inch by a track recording density of 1,945,000 bits per 1 inch and a track density per 1 inch of 471,000 tracks could be confirmed.

1. A perpendicular magnetic recording medium comprising:
a substrate;
a soft magnetic under layer formed over said substrate;
a seed layer comprising an upper layer and a lower layer formed over said soft magnetic underlayer;
an intermediate layer formed of Ru or an Ru alloy formed over said seed layer; and
a recording layer formed over said intermediate layer, forming a grain isolation layer on said upper layer of the seed layer.

2. The perpendicular magnetic recording medium of claim 1 wherein said seed layer comprises a nickel-tungsten alloy.

3. The perpendicular magnetic recording medium of claim 2 wherein said nickel-tungsten alloy comprises Aluminum.

4. The perpendicular magnetic recording medium of claim 2 wherein said nickel-tungsten alloy comprises Zirconium.

5. The perpendicular magnetic recording medium of claim 2 wherein said nickel-tungsten alloy comprises Niobium.

6. The perpendicular magnetic recording medium according to claim 1, wherein said grain isolation layer contacts said intermediate layer.

7. The perpendicular magnetic recording medium according to claim 1, wherein said grain isolation layer contains an oxide.

8. The perpendicular magnetic recording medium according to claim 1, wherein said seed layer does not contain an oxide.

9. The perpendicular magnetic recording medium according to claim 1, wherein said grain isolation layer is formed of an NiW alloy comprising an oxide.

10. The perpendicular magnetic recording medium according to claim 1, wherein a film thickness of said grain isolation layer is not more than 0.5 nm and less than 3 nm.

11. The perpendicular magnetic recording medium according to claim 1, wherein a film thickness of said seed layer is not less than 2 nm and not more than 5 nm.

12. A perpendicular magnetic recording medium comprising:
a substrate;
an adhesion layer formed over said substrate;
a magnetic undercoat layer formed over said adhesion layer;
a soft magnetic under layer formed over said magnetic undercoat layer;
a seed layer comprising an upper layer and a lower layer formed over said soft magnetic underlayer;
a grain isolation layer formed over said seed layer;
an intermediate layer formed of Ru or an Ru alloy formed over said grain isolation layer; and
a recording layer formed over said intermediate layer, coupled with said grain isolation layer.

13. The perpendicular magnetic recording medium of claim 12 wherein said seed layer comprises a nickel-tungsten alloy.

14. The perpendicular magnetic recording medium of claim 12 wherein said nickel-tungsten alloy comprises Zirconium.

15. The perpendicular magnetic recording medium of claim 12 wherein said nickel-tungsten alloy comprises Niobium.

16. The perpendicular magnetic recording medium according to claim 12, wherein said grain isolation layer contacts said intermediate layer.

17. The perpendicular magnetic recording medium according to claim 12, wherein said grain isolation layer contains an oxide.

18. The perpendicular magnetic recording medium according to claim 12, wherein said seed layer does not contain an oxide.

19. The perpendicular magnetic recording medium according to claim 12, wherein said grain isolation layer is formed of an NiW alloy comprising an oxide.

20. The perpendicular magnetic recording medium according to claim 12, wherein a film thickness of said grain isolation layer is not more than 0.5 nm and less than 3 nm.

21. The perpendicular magnetic recording medium according to claim 12, wherein a film thickness of said seed layer is not less than 2 nm and not more than 5 nm.

22. A method for forming a perpendicular magnetic recording medium comprising:
providing a substrate;
forming a soft magnetic under layer formed over said substrate;
forming a seed layer comprising an upper layer and a lower layer over said soft magnetic underlayer;
forming an intermediate layer of Ru or an Ru alloy over said seed layer; and
forming a recording layer over said intermediate layer, forming a grain isolation layer on said upper layer of the seed layer.

23. The method of claim 22 wherein said seed layer comprises a nickel-tungsten alloy.

24. The method of claim 22 wherein said nickel-tungsten alloy comprises Aluminum.

25. The method of claim 22, wherein said grain isolation layer contacts said intermediate layer.
